(19) United States
(12) Patent Application Publication
(10) Pub. No.: US 2019/0265761 A1
(43) Pub. Date: Aug. 29, 2019

(54) EXTERNAL ELECTRONIC DEVICE

(71) Applicant: ASUSTeK COMPUTER INC., Taipei (TW)

(72) Inventors: Hsin-Chen Lin, Taipei (TW); Ing-Jer Chiou, Taipei (TW)

(21) Appl. No.: 16/411,328

(22) Filed: May 14, 2019

Related U.S. Application Data
(62) Division of application No. 15/851,216, filed on Dec. 21, 2017.

(30) Foreign Application Priority Data
Jan. 4, 2017 (CN) 201720005899.5

(51) Int. Cl. G06F 1/18; E05D 3/18; G11B 17/04; G11B 33/02; G06F 1/20; E05D 15/50

(52) U.S. Cl. CPC G06F 1/181; E05D 3/183; G11B 17/0405; E05D 1/06; G06F 1/20; E05D 15/502; E05Y 2900/132; G11B 33/027

(57) ABSTRACT

An electronic device is provided. The electronic device includes a casing and a moveable plate. The moveable plate disposed at the outside of the casing via the hinge. The moveable plate is selectively moved toward or away from the casing.

### CROSS-REFERENCE TO RELATED APPLICATION

This application is a Division of application Ser. No. 15/851,216, filed on Dec. 21, 2017, with claiming foreign priority of CN 201720005899.5. The prior application is herewith incorporated by reference in its entirety.

### BACKGROUND OF THE INVENTION

### Field of the Invention

The disclosure relates to an electronic device and, more particularly, to a casing structure of an electronic device.

### Description of the Related Art

As electronic devices speed up to cause that heat generated by the electronic devices is increased. As a result, the electronic devices are easily overheated. In general, the solution is to increase the size of the fan in the electronic device to improve the heat dissipation performance. However, with the trend of miniaturization of electric devices, the size of the fan is limited by the casing space of the electronic device.

### BRIEF SUMMARY OF THE INVENTION

The disclosure discloses a method for controlling an electronic device with a touch panel. The method includes the steps of: determining whether an electronic device is operated in a stylus mode or a general mode.

These and other features, aspects and advantages of the present disclosure will become better understood with regard to the following description, appended claims, and accompanying drawings.

### BRIEF DESCRIPTION OF THE DRAWINGS

Figures described below are some embodiments of the disclosure, and skilled people in the art can acquire other figures according to the figures without creative work.

FIG. 1 is a schematic diagram showing an electronic device according to an embodiment of the disclosure;

FIG. 2 is a section view showing an electronic device according to an embodiment of the disclosure;

FIG. 3 is a section view showing an electronic device according to an embodiment of the disclosure;

FIG. 4 is a section view showing an electronic device according to an embodiment of the disclosure;

FIG. 5 is a section view showing an electronic device according to an embodiment of the disclosure;

FIG. 6 is a section view showing an electronic device according to an embodiment of the disclosure;

FIG. 7 is a section view showing an electronic device according to an embodiment of the disclosure;

FIG. 8 is a section view showing an electronic device according to an embodiment of the disclosure;

FIG. 9 is a section view showing an electronic device according to an embodiment of the disclosure;

FIG. 10 is a section view showing an electronic device according to an embodiment of the disclosure;

FIG. 11 is a section view showing an electronic device according to an embodiment of the disclosure;

FIG. 12 is a section view showing an electronic device according to an embodiment of the disclosure;

FIG. 13 is a section view showing an electronic device according to an embodiment of the disclosure;

FIG. 14 is a section view showing an electronic device according to an embodiment of the disclosure;

FIG. 15 is a section view showing an electronic device according to an embodiment of the disclosure;

FIG. 16 is a section view showing an electronic device according to an embodiment of the disclosure;

FIG. 17 is a section view showing an electronic device according to an embodiment of the disclosure;

FIG. 18 is a section view showing an electronic device according to an embodiment of the disclosure; and

FIG. 19 is a section view showing an electronic device according to an embodiment of the disclosure.

### DETAILED DESCRIPTION OF THE EMBODIMENTS

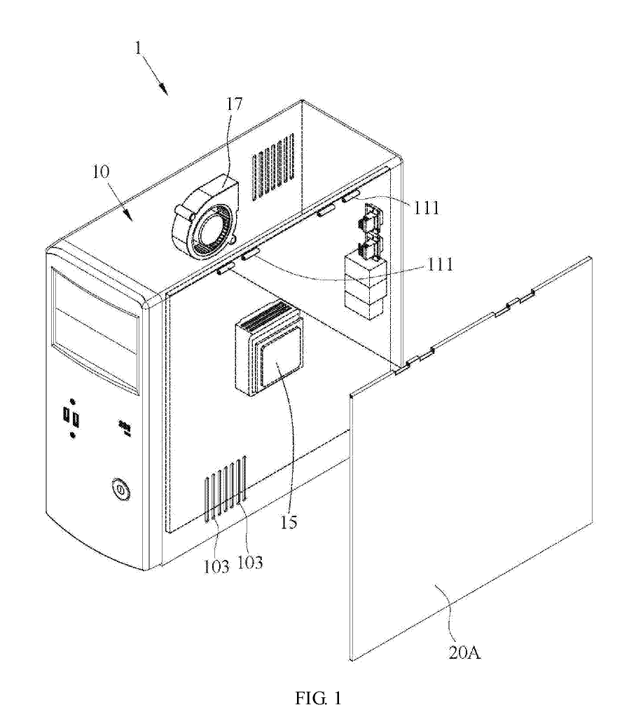

FIG. 1 is a schematic diagram according to an embodiment of the disclosure. In the embodiment, the electronic device 1 is a desktop computer or a notebook computer. The electronic device 1 includes a casing 10 and a moveable plate 20A disposed outside the casing 10. Multiple electronic components 15 are disposed in the casing 10. In an embodiment, the electronic component 15 is a motherboard, a Central Processing Unit (CPU), a display card, a memory card, or a combination thereof.

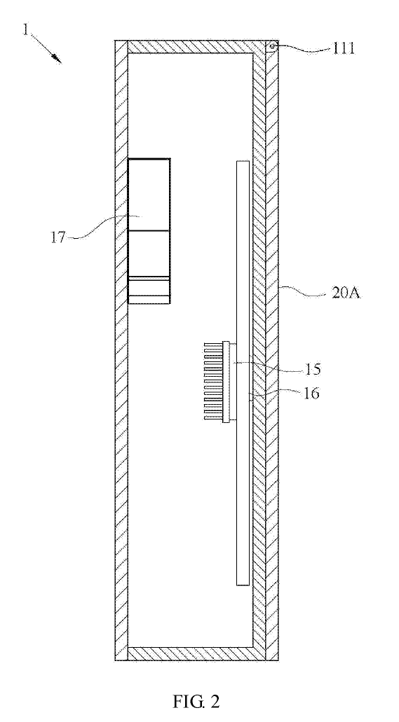

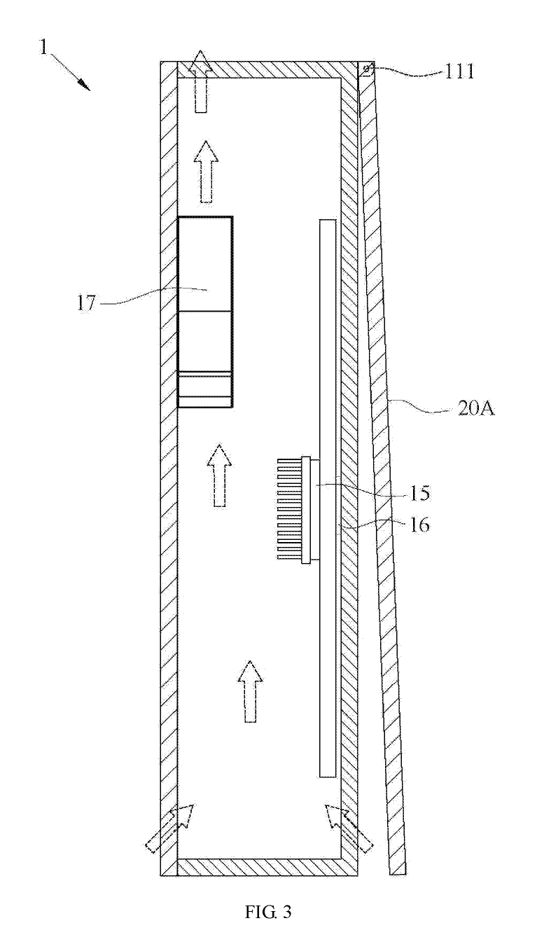

FIG. 2 and FIG. 3 are section views showing an electronic device according to an embodiment of the disclosure. In an embodiment, an end of the moveable plate 20A is connected with the casing 10 via a hinge 111. The moveable plate 20A is moveable connected to the casing 10 to move close to or far away from the casing 10. In an embodiment, the hinge 111 is a bearing. As shown in FIG. 2, when the electronic device 1 is turn off, the moveable plate 20A is moved close to the casing 10. As shown in FIG. 3, when the electronic device 1 is turned on, an end of the moveable plate 20A is moved far away from the casing 10 to dissipate the heat generated by the electronic components 15 out of the casing 10.

Please also refer to FIG. 3. When the electronic device 1 is turned on, the heat generated by the electronic components 15 is directly transferred to the casing 10 via a heat conductor 16. In an embodiment, the heat conductor 16 is a heat pipe or a heat plate.

As shown in FIG. 3. The casing 10 further includes a fan 17. Ventilation openings 103 (as shown in FIG. 1) are formed on the surface of the casing 10. When the moveable plate 20A is moved far away from the casing 10, the airflow enters the casing 10 via the ventilation openings 103 of the casing 10 to have a heat exchange with the electronic components 15.

As shown in FIG. 4. FIG. 4 is a section view showing an electronic device according to an embodiment of the disclosure. The electronic device 1 includes a driving unit 30 disposed at a side of the casing 10 opposite to the side of the hinge 111. The driving unit 30 includes a driving part 31 and an extensible part 32. In an embodiment, the driving part 31 is a motor, and the extensible part 32 is a linkage lever. An end of the extensible part 32 is connected to the moveable plate 20A, and the other end of the extensible part 32 is connected with the driving part 31. In an embodiment, the driving part 31 is connected with the extensible part 32 via a gear set to drive the extensible part 32 to move relative to the casing 10. During the operation, the driving part 31 drives the extensible part 32 to extend relative to the casing 10. Then, the moveable plate 20A is driven to move to adjust the distance between the moveable plate 20A and the casing 10. The distance between the moveable plate 20A and the casing 10 can be adjusted according to requirements, such as a temperature of the casing 10.

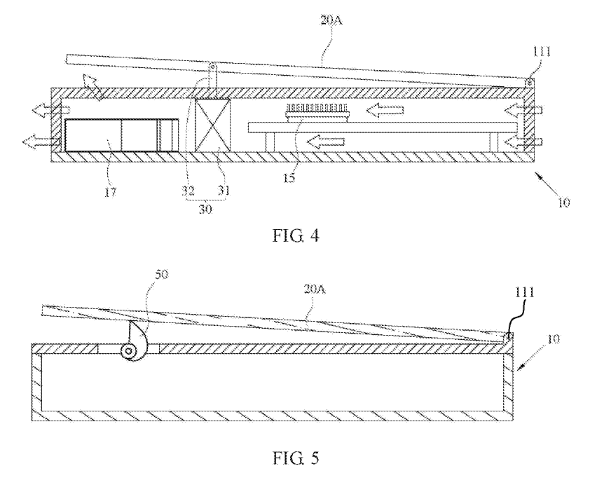

As shown in FIG. 5. FIG. 5 is a section view showing an electronic device according to an embodiment of the disclosure. In the embodiment, the driving unit 50 is a cam pivotally disposed on a side of the casing 10 opposite to the hinge 111. The driving unit 50 adjusts the distance between the moveable plate 20A and the casing 10 via the rotation of the driving unit 50.

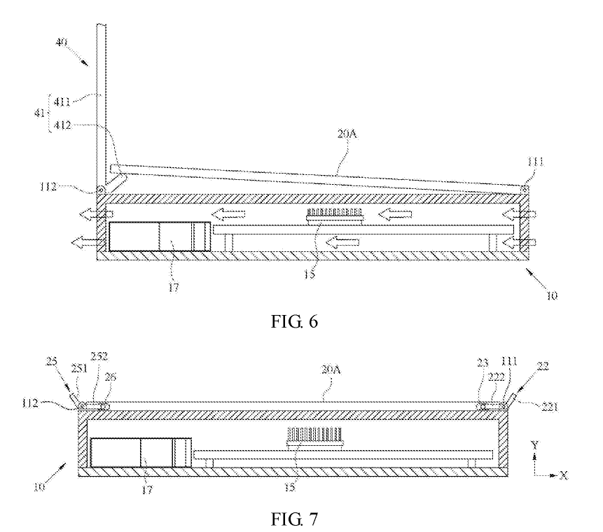

As shown in FIG. 6. FIG. 6 is a section view showing an electronic device according to an embodiment of the disclosure. In the embodiment, the electronic device 1 is a notebook computer. A hinge 112 is disposed on a side of the casing 10 opposite to the side of the hinge 111. In an embodiment, the hinge 112 is a pivot, a bearing, or a bearing hole. The driving unit 40 includes a connecting unit 41. The connecting unit 41 is pivotally connected to the hinge 112. The connecting unit 41 includes an actuator 411 and a connecting part 412. An angle is formed between the actuator 411 and the connecting part 412. One end of the connecting part 412 abuts against a surface of the moveable plate 20A close to the casing 10. During the operation, the actuator 411 is controlled to rotate around the hinge 112 to open or close the moveable plate 20A. In an embodiment, the actuator 411 is a display panel of a notebook computer. When the display panel is open, the connecting part 412 abuts against the surface of the moveable plate 20A to drive the moveable plate 20A to rotate to maintain a distance away from the casing 10.

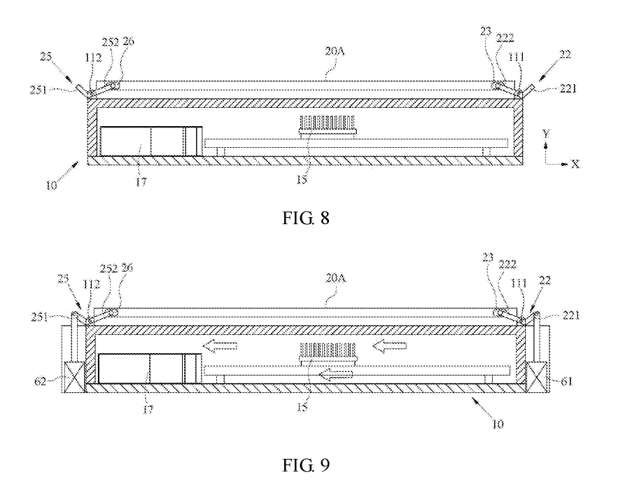

FIG. 7 and FIG. 8 are section views showing an electronic device according to an embodiment of the disclosure. In the embodiment, a first connecting unit 22 and a first sliding slot 23 are configured at an end of the moveable plate 20A, a second connecting unit 25 and a second sliding slot 26 are configured at the other of the moveable plate 20A. An end of the first connecting unit 22 is pivotally connected to the first sliding slot 23, and the other end of the first connecting unit 22 is pivotally connected to the hinge 111. An end of the second connecting unit 25 is pivotally connected to the second sliding slot 26, and the other end of the second connecting unit 25 is pivotally connected to the hinge 112.

Please refer to FIG. 8. During the operation, the moveable plate 20A is controlled to move along the Y axis relatively to the casing 10, an end of the first connecting unit 22 moves in the first sliding slot 23, and an end of the second connecting unit 25 moves the second sliding slot 26 respectively. The other end of the first connecting unit 22 rotates around the hinge 111, and the other end of the second connecting unit 25 rotates around the hinge 112 respectively. Then, the moveable plate 20A moves close to or away from the casing 10.

As shown in FIG. 7 and FIG. 8, the first connecting unit 22 includes a first actuator 221 and a first connecting part 222 connected to the hinge 111, respectively. An angle is formed between the first actuator 221 and the second connecting part 222. The second connecting unit 25 includes a second actuator 251 and a second connecting part 252 connected to the hinge 112, respectively. An angle is formed between the second actuator 251 and the second connecting part 252. When a force is applied to the first actuator 221 and the second actuator 251, the first connecting unit 22 rotates around the hinge 111, and the second connecting unit 25 rotates around the hinge 112, respectively. Then, the first connecting part 222 and the second connecting part 252 drives the moveable plate 20A to move, and the distance between the moveable plate 20A and the casing 10 is adjusted.

FIG. 9 is a section view showing an electronic device according to an embodiment of the disclosure. In the embodiment, the electronic device 1 includes a first driving unit 61 and a second driving unit 62 disposed outside the casing 10. The first driving unit 61 is connected to the first actuator 221 to drive the first connecting unit 22 to rotate around the hinge 111. The second driving unit 62 is connected to the second actuator 251 to drive the second connecting unit 25 to rotate around the hinge 112.

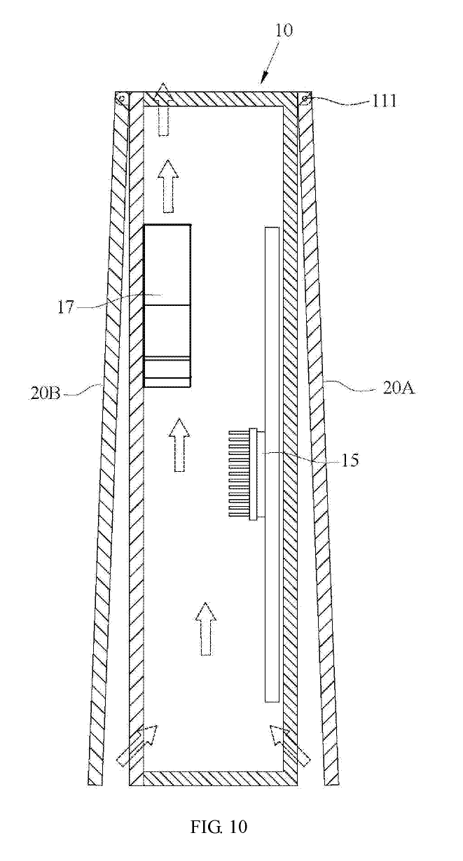

FIG. 10 is a section view showing an electronic device according to an embodiment of the disclosure. In the embodiment, the electronic device 1 includes two moveable plates 20A, 20B. One end of two moveable plates 20A, 20B is pivotally connected with two sides of the outer casing 10 respectively, to adjust the distance between the two moveable plates 20A, 20B and the casing 10, respectively.

FIG. 11 is a section view showing an electronic device according to an embodiment of the disclosure. In the embodiment, the electronic device 1 includes a driving rod set 70. The driving rod set 70 is disposed at a side of the casing 10 far away from the hinge 111. The driving rod set 70 includes a first connecting rod 71, a second connecting rod 72, and an extensible rob 73. An end of the first connecting rod 71 is pivotally connected to the extensible rob 73, and the other end of the first connecting rod 71 is pivotally connected to the moveable plate 20A. An end of the second connecting rod 72 is pivotally connected to the extensible rob 73, and the other end of the second connecting rod 72 is pivotally connected to the other moveable plate 20B. During the operation, the extensible rob 73 is controlled to move relatively to the casing 10, to drive the moveable plate 20A, 20B to move close to or far away from the casing 10.

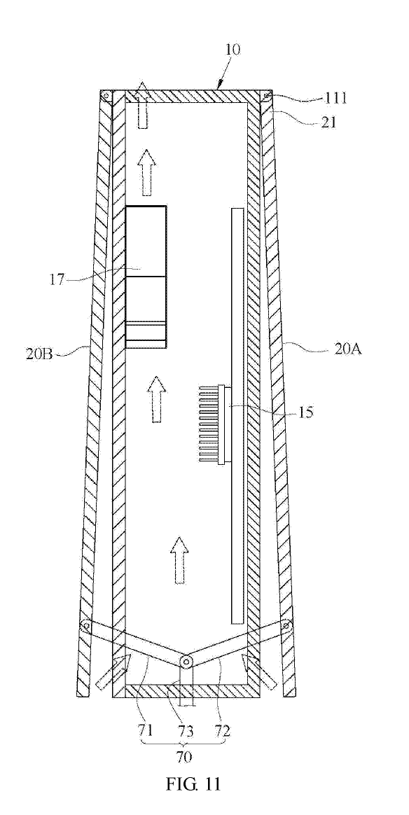

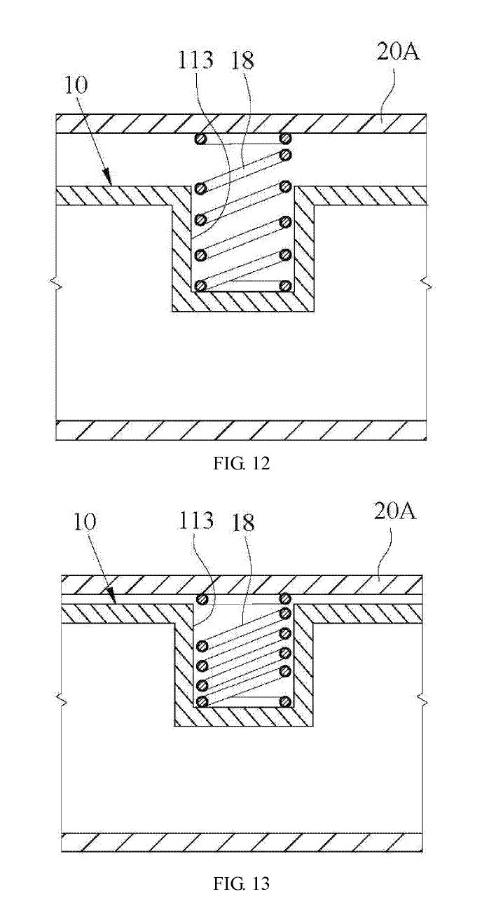

FIG. 12 and FIG. 13 are section views showing an electronic device according to an embodiment of the disclosure. As shown in FIG. 12 and FIG. 13, in the embodiment, the casing 10 includes a groove 113. An elastic element 18 is disposed in the groove 113. In the embodiment, the elastic element 18 is a spring. An end of the elastic element 18 is connected to the moveable plate 20A, and the other end of the elastic element 18 is fixedly connected to the casing 10. The moveable plate 20A presses or releases the elastic element 18 to move close to or far away from the casing 10.

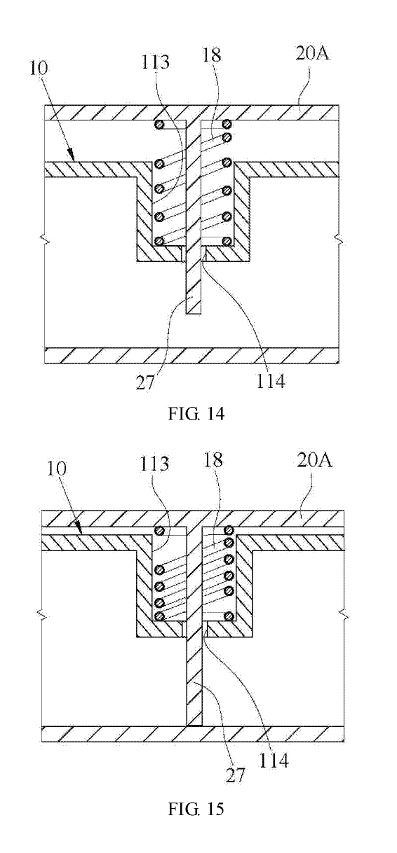

FIG. 14 and FIG. 15 are section views showing an electronic device according to an embodiment of the disclosure. As shown in FIG. 14 and FIG. 15, in the embodiment, the groove 113 includes an opening 114. A guiding pillar 27 protrudes from the moveable plate 20A. The guiding pillar 27 passes through the opening 114 and moves relatively to the opening 114. The elastic element 18 is sleeved on the guiding pillar 27. The moveable plate 20A moves close to or away from the casing 10 via the moving of the guiding pillar 27.

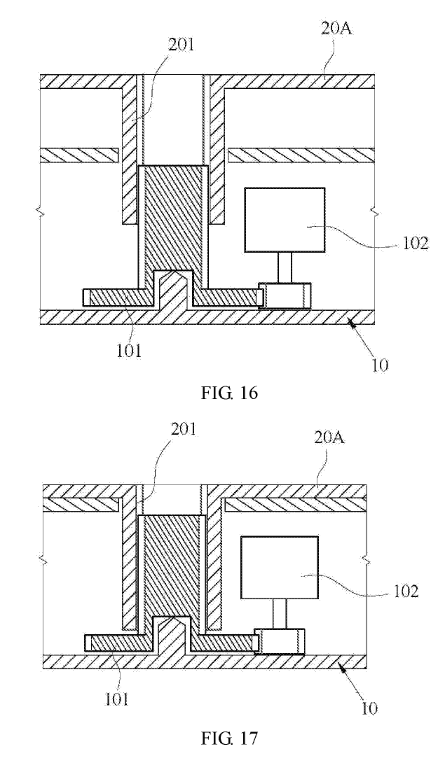

FIG. 16 and FIG. 17 are section views showing an electronic device according to an embodiment of the disclosure. In the embodiment, the casing 10 includes a first screw component 101. The moveable plate 20A includes a second screw component 201. The first screw component 101 is screwed with the second screw component 201. The first screw component 101 is connected to a driver 102 (such as a motor). The first screw component 101 is driven by the driver 102 to rotate backwardly or forwardly relative to the casing 10 to adjust the distance between the moveable plate 20A and the casing 10.

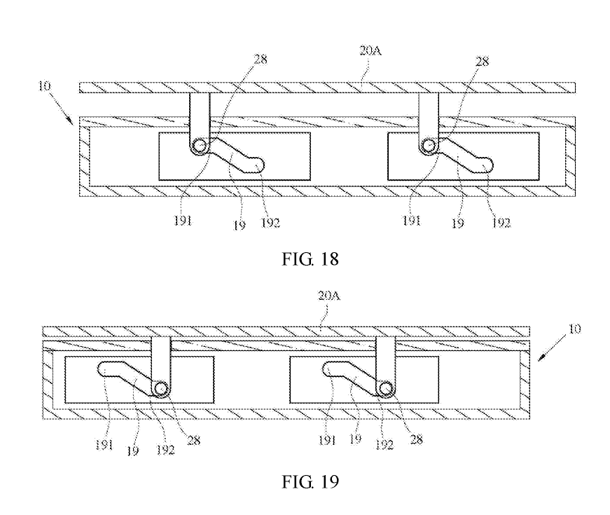

FIG. 18 and FIG. 19 are section views showing an electronic device according to an embodiment of the disclosure. In the embodiment, two sliding tracks 19 are configured at a side of the casing 10. Each sliding track 19 includes a first end 191 and a second end 192. The first end 191 is closer to the moveable plate 20A than the second end 192. Two sliding blocks 28 are protrudes from the moveable plate 20A sliding block. The sliding blocks 28 are slidably disposed in the sliding tracks 19, respectively. During the operation, the sliding blocks 28 slides between the first end 191 and the second end 192 of the sliding track 19 to adjust the distance between the moveable plate 20A and the casing 10.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device, comprising:
a casing, including a hinge and a surface, multiple electronic components are disposed in the casing and the heat generated by the electronic components is transferred to the casing, the hinge is disposed on the one side of the surface, and a ventilation opening is formed on the surface;
a moveable plate, configured outside the casing via the hinge, and the moveable plate is selectively moved close to or away from the surface of the casing, when the moveable plate is moved far away from the casing, the airflow enters the casing via the ventilation opening to have a heat exchange with the electronic components; and
a driving unit, connected to a side of the casing opposite to the side of the hinge, the driving unit drives the moveable plate to adjust the distance between the moveable plate and the casing, and the distance between the moveable plate and the casing adjusted according to a temperature of the casing.

2. The electronic device according to claim 1, wherein the driving unit is a cam, and the cam is pivotally connected with the casing and abuts against the moveable plate.

3. The electronic device according to claim 1, wherein the driving unit comprises a driving part and an expansion part, an end of the extensible part is connected to the moveable plate, and the other end of the extensible part is configured at the driving part.

4. The electronic device according to claim 1, wherein the driving unit comprises a connecting unit, the connecting unit includes an actuator and a connecting part, an angle is formed between the actuator and the connecting part, the actuator and the connecting part are pivotally connected with the casing, respectively, and an end of the connecting part abuts against a surface of the moveable plate adjacent to the casing.

5. The electronic device according to claim 1, wherein a first connecting unit and a first sliding slot are configured at an end of the moveable plate, a second connecting unit and a second sliding slot are configured at another end of the moveable plate, an end of the first connecting unit is pivotally connected to the first sliding slot, another end of the first connecting unit is pivotally connected to the casing, an end of the second connecting unit is pivotally connected to the second sliding slot, and another end of the second connecting unit is pivotally connected to the casing.

6. The electronic device according to claim 5, wherein the first connecting unit includes a first actuator and a first connecting part, the first actuator and the first connecting part are pivotally connected to the casing, respectively, the second connecting unit includes a second actuator and a second connecting part, and the second actuator and the second connecting part are pivotally connected to the casing, respectively.

7. The electronic device according to claim 6, further comprising:
a first driving unit and a second driving unit, the first driving unit is connected to the first actuator to drive the first connecting unit, and the second driving unit is connected to the second actuator to drive the second connecting unit.

8. The electronic device according to claim 1, further comprising:
another moveable plate configured at a side of the casing opposite to the side of the moveable plate, and an end of the another moveable plate is pivotally connected with the casing.

9. The electronic device according to claim 8, further comprising:
a driving rod set including a first connecting rod, a second connecting rod, and an extensible rob, wherein a first end of the first connecting rod is pivotally connected with the extensible rob, a second end of the first connecting rod is pivotally connected with the moveable plate, a first end of the second connecting rod is pivotally connected with the extensible rob, and a second end of the second connecting rod is pivotally connected with the another moveable plate.

10. The electronic device according to claim 1, wherein a groove is formed at the casing, an elastic element is disposed in the groove, an end of the elastic element is fixedly connected with the moveable plate, and another end of the elastic element is fixedly connected with the casing.

11. The electronic device according to claim 10, wherein the groove includes an opening, a guiding pillar protrudes from the moveable plate, the guiding pillar moveably passes through the opening, and the elastic element is sleeved on the guiding pillar.

12. The electronic device according to claim 1, wherein the casing includes a first screw component, the moveable plate includes a second screw component, the first screw component is screwed with the second screw component, and the first screw component is rotatable relatively to the casing.

13. The electronic device according to claim 1, wherein the casing includes a sliding track, the sliding track includes a first end and a second end, the first end is closer to the moveable plate than the second end, a sliding block protrudes from the moveable plate, and the sliding block is slidably disposed in the sliding track.
